(19) United States
(12) Patent Application Publication
(10) Pub. No.: US 2013/0054282 A1
(43) Pub. Date: Feb. 28, 2013

(54) FOR-HIRE VEHICLE UTILIZATION SYSTEM AND METHOD

(71) Applicants: Michael Collins Pinkus, Alpharetta, GA (US); Mark Alden James, Las Vegas, NV (US)

(72) Inventors: Michael Collins Pinkus, Alpharetta, GA (US); Mark Alden James, Las Vegas, NV (US)

(73) Assignee: FRIAS TRANSPORTATION INFRASTRUCTURE LLC, Las Vegas, NV (US)

(21) Appl. No.: 13/600,174

(22) Filed: Aug. 30, 2012

Related U.S. Application Data
(60) Provisional application No. 61/529,819, filed on Aug. 31, 2011.

(51) Int. Cl. G06Q 10/02

(52) U.S. Cl. 705/5

(57) ABSTRACT

Systems and methods for managing for-hire-vehicle (FHV) services are disclosed. The system can include one or more kiosks in communication with a central computing system. The kiosks may be located or near transportation terminals or entertainment venues, such as airports, hotels, casinos, and entertainment attractions. A passenger may make a reservation for transportation service at a kiosk and receive a voucher that may be collected or validated by the service provider at the time of transport. The voucher may be printed at the kiosk, or it may be sent electronically to the mobile device of the passenger. The voucher can provides a unique serialized voucher number that is associated with the reservation, which may be read or scanned upon redemption of the voucher. The voucher may have promotional materials printed thereon.

### RELATED APPLICATIONS

This application claims priority from, U.S. Provisional Patent Application No. 61/529,819, filed Aug. 31, 2011, which is expressly incorporated by reference herein in its entirety and made a part of the present disclosure.

### BACKGROUND

Generally, when airline travelers arrive at a location, they require ground transportation to their ultimate destination. Some travelers choose to employ the use of a for-hire vehicle, such as a shuttle, taxi, bus or limousine to transport them to their final destination. Shuttles may be advantageous for some travelers because they offer door-to-door service and are generally less expensive than taxis or limousines. For other travelers a taxi, limousine or bus service may be more appropriate.

### BRIEF DESCRIPTION OF DRAWINGS

FIG. 1 illustrates an embodiment of a system for managing for-hire-vehicle (FHV) transactions.

FIG. 2 is a flowchart illustrating an embodiment of a process 200 for generating and delivering vouchers.

FIG. 3 is a flowchart illustrating an embodiment of a process 300 for real-time location-based upselling.

FIG. 4 illustrates one embodiment of a user interface screen that may be displayed on the kiosk.

FIGS. 5 and 6 illustrate one embodiment of a route information screen that may be displayed on the kiosk. FIG. 5 shows a main view of the route information screen, while FIG. 6 shows a detail of the first shuttle route option presented in FIG. 2.

FIG. 7 illustrates one embodiment of a round trip request user interface.

FIG. 8 illustrates one embodiment of a date selector user interface for selecting the date of a return trip for a round trip reservation.

FIG. 9 illustrates one embodiment of a payment confirmation screen.

FIG. 10 illustrates one embodiment of a user interface for inputting a mobile telephone number so that the passenger may receive a voucher receipt or alerts to his mobile phone.

FIG. 11 illustrates one embodiment of the kiosk.

### DESCRIPTION OF EMBODIMENTS

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the embodiments of the disclosure herein described.

The various illustrative logical blocks, modules, data structures, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, modules, and processes described herein may instead be implemented monolithically.

The various illustrative logical blocks, modules, data structures, and processes described herein may be implemented or performed by a machine, such as a computer, a processor, a digital signal processor (DSP), an application specific integrated circuit (ASIC), a filed programmable gate array (FPGA) or other programmable logic device, discrete gate or transistor logic, discrete hardware components, or any combination thereof designed to perform the functions described herein. A processor may be a microprocessor, a controller, a microcontroller, a state machine, combinations of the same, or the like. A processor may also be implemented as a combination of computing devices—for example, a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware, in a software module executed by a processor, or in a combination of the two. For example, each of the processes described above may also be embodied in, and fully automated by, software modules executed by one or more machines such as computers or computer processors. A module may reside in a computer-readable storage medium such as RAM memory, flash memory, ROM memory, EPROM memory, EEPROM memory, registers, a hard disk, a removable disk, a CD-ROM, memory capable of storing firmware, or any other form of computer-readable storage medium. An exemplary computer-readable storage medium can be coupled to a processor such that the processor can read information from, and write information to, the computer readable storage medium. In the alternative, the computer-readable storage medium may be integral to the processor. The processor and the computer-readable storage medium may reside in an ASIC.

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The embodiments described herein provide a system for reserving shuttle service. The system comprises one or more kiosks in communication with a central computing system. The kiosks may be geographically distributed, that is, they may be located in different cities, or at different venues, such as airports, hotels, casinos, and entertainment attractions, within the same city. A passenger may make a reservation for shuttle service at a kiosk and receive a voucher that may be collected or validated by the shuttle service at the time of transport. The voucher may be printed at the kiosk, or it may be sent electronically to the mobile device of the passenger. The voucher advantageously provides a unique serialized voucher number that is associated with the reservation. Upon redemption, a driver may scan a UPC or QR code of the voucher, or may input the serialized voucher number, into a driver-computing device to validate the voucher. Once the driver drops off the passenger, the driver may enter an indication that the trip is complete thereby permitting the central computing system the ability to collect and analyze data related shuttle reservations and utilization.

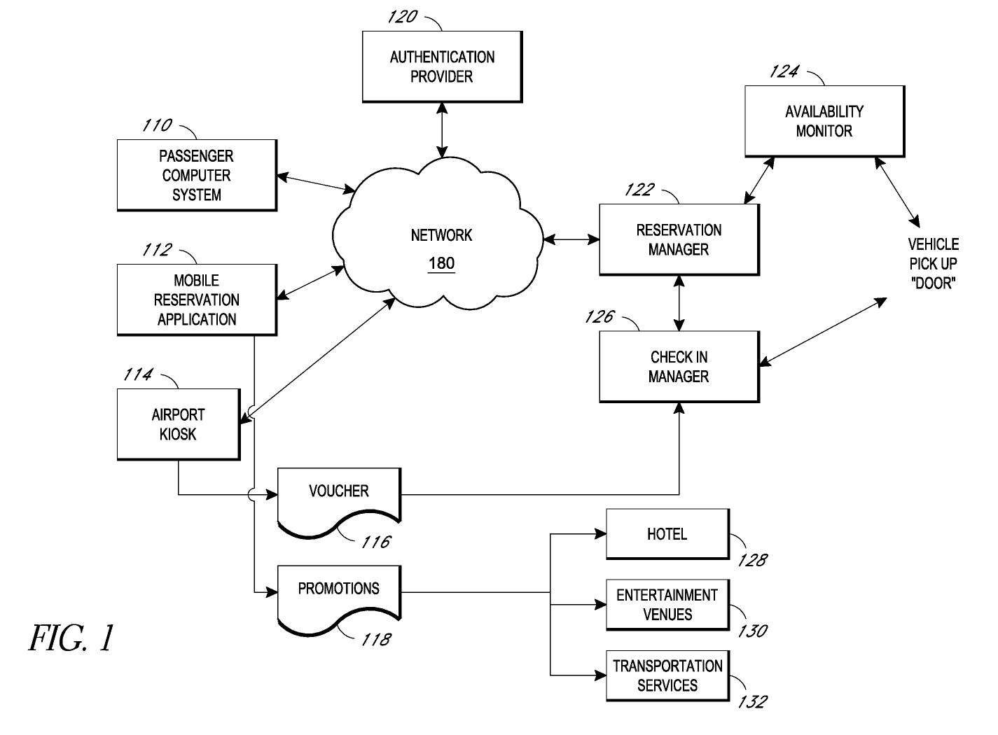

FIG. 1 illustrates an embodiment of a system 100 for managing for-hire-vehicle (FHV) transactions. The system 100 may include a passenger computer system 110. For example, the passenger computer system may be operated by a consumer (i.e., individual ordering FHV services) for the purpose of reserving FHV services. The passenger computer system may be configured to connects to a reservation manager module 122 over a network 180, such as the Internet. The passenger computer system may include a web server or dedicated client application that could be used by travel agents and other entities. In certain embodiments, the passenger computer system 110 receives alert notifications and/or vouchers via an email client. Furthermore, the system 110 may be connected to a printer to print vouchers. Examples of passenger computer systems 110 may include laptops, desktops, tablets, or other computing devices.

The system 100 may include an authentication provider module 120. For example, the authentication provider module 120 may be a third-party entity that provides authentication services to the registration manager module 122. In addition, the authentication provider 120 may provide additional information about passengers, such as, e.g., shopping tendencies/preferences, gambling history, food preferences, places travelled to, currently location, etc. Example authenticators may include Google Authenticator and Facebook Authentication, which use two-factor authentication tokens.

In certain embodiments, the system 100 includes a mobile reservation application 112, such as an application running on a mobile device (e.g., Android, iPhone). The mobile reservation application 112 may interface with a mobile device's GPS module to help determine the location of the device/passenger. Furthermore, the application 112 may receive alert notifications from the reservation manager regarding a reservation. In certain embodiments, the mobile reservation application 112 receives electronic vouchers, such as vouchers containing a QR code or UPC code that can be scanned, or may include a serialized identifier. In addition, the application 112 may receive promotions, such as, coupons or tickets, which may include one or more QR codes, UPCs, serialized identifiers, or the like. Additional promotions may include free downloads or other programs that may be received free or at a discount.

The system 100 may include a kiosk 114, such as a kiosk located at or near an airport or other transportation terminal. The kiosk 114 is a dedicated computer system for making or editing reservations, and may be connected to and forms part of a comprehensive passenger service network. For example, the kiosk 114 may be connected to a printer for printing vouchers, such as voucher containing UPC, QR Code, serialized id number, or other identification number or numbers. The voucher may be a booklet, magazine, or other multi-page item. For example, the voucher may be a booklet with a voucher number or code printed on an outside portion or inner page of the booklet. In certain embodiments, at least one page has promotional content printed thereon that the user may read upon receiving the voucher. For example, the user may wish to read the material while waiting for transportation service. The promotional content may be pre-printed on the pamphlet prior to printing the voucher code, or may be In certain embodiments, the kiosk includes one or more cameras and/or microphones to permit visual contacts with customer service and to keep visual and voice record of each customer.

The reservation manager 122 may provide one or more websites for reserving limos. Such websites may include account management functionality and may accept authentication from third party providers. In addition, such websites may allow customers to view available FHVs (e.g., limos) in real time (possibly including a location map), as well as stored photos of the exterior and interior of the particular vehicle that is being viewed in real time. Websites may further permit instant, or near instant, contact by text or other mechanism with references who have recently been in a particular vehicle.

In certain embodiments, the reservation manager 122 provides a module for determining targeted promotional content for presentation to consumers. Such targeted promotional content may be based on one or more of the following factors: authentication profile; past order history; location; time; or other factors. The reservation manager 122 may be configured to generates alerts/notifications, such as to indicate that an FHV is ready for service, or other FHV status information. Alerts/notifications may include, for example, photograph or video content (streaming) of actual vehicles waiting along with map showing current location. Furthermore, the alerts/notifications may indicate the availability of upgrades. In certain embodiments, the reservation manager 122 is configured to notify a consumer of receipt of a reservation, or that a customer account has been changes/updated in some way.

The reservation manager 122 may generates images for vouchers or promotions. Once generated, images may be sent to the passenger computer system 110, mobile reservation application 112, and/or airport kiosk 114. In certain embodiments, the reservation manager 122 is configured to interface with an availability monitor module 124 to determine if alerts should be generated. The reservation manager 122 may further be configured to interfaces with a check-In manager module 126.

The availability monitor 124 may be connected to a sensor that determines what cars are waiting curbside. For example, cars may have RFID tags that uniquely identify the car, wherein the sensor of the availability monitor is an RFID reader. Visual detection based on license number/medallion number(?)/license plate. In certain embodiments, FHV drivers possess a badge/card with a magnetic strip or RFID tag that can be used to notify the system 100 that car is available. A cooresponding sensor may be disposed at or near curbside. The availability monitor may further include an associated system so that an operator may verify scanning is working properly, or modify available car queue list for passengers

The check-in manager 126 may be configured to maintain passenger records to determine if a generated voucher has been cashed in. The check-in manager may include a reader to read the generated vouchers. For example, the check-in manager 126 could be a handheld device, or application running on a normal desktop in communication with a peripheral scanning device.

The system 100 includes business entities associated with voucher/promotion transactions. For example, hotels, various entertainment venues, and/or transportation services may accept and record/scan promotion vouchers. With respect to transportation services, for example, a group of limos may be tied together by Skype video and audio to permit speaker phone and video link among groups of consenting passengers. Such a system could be set up during the reservation process, such as at the kiosk 114. Webcams and/or microphones disposed within FHVs could be used for security purposes (for example, facial recognition and matching programs could be used to check that the same person who checked in at the kiosk is in the vehicle; tour promoter may use this as a way to confirm that all participants in the tour are on board). Redemption venues may communicate voucher redemptions back to the reservation manager 122 to confirm that promotions were used. Such feedback could be used in selecting future promotional content.

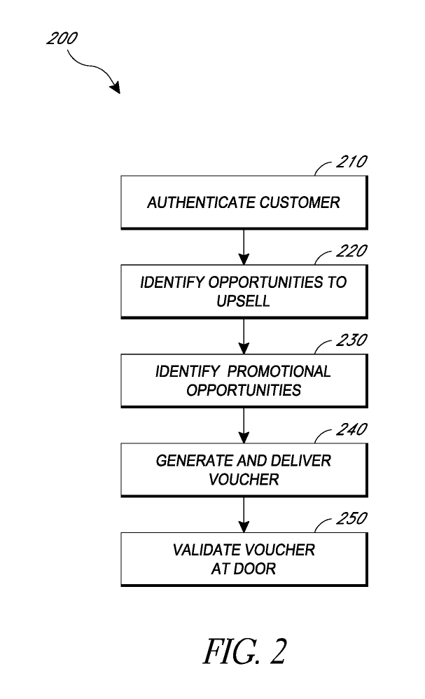

FIG. 2 is a flowchart illustrating an embodiment of a process 200 for generating and delivering vouchers. In certain embodiments, the process 200 begins with authenticating a customer at block 210. Authentication may be done in response to a customer/passenger logging-in to a website (e.g., a website generated by the reservation manager 122) to reserve a car. If the customer has not previously logged-in to the system or created a system profile, it may be necessary or desirable for the customer to do so prior to being authenticated. A user profile may contain information that could be used for promotions and/or upsells. For example, interest in high ticket merchandise may trigger upsell for stretch limo; interest in certain beverages may trigger upsell for limo with drink service; interest in environment may trigger “green” limo upsell; interest in music may trigger upsell for limo with high end audio system. The customer may also enter payment information, which may be saved in the customer's user profile, to facilitate quick transactions. In certain embodiments, authentication is carried out by a third party entity, or by the reservation manager 122. The customer may be able to reserve space in an FHV after authentication

The process 200 may further include identifying opportunities to upsell the customer at block 220. Before reservation is confirmed, the process may include determining if an upsell opportunity exists. Such a determination may be based on profile information and/or past reservation/transaction history. In certain embodiments, a voucher is set up to provide a fixed fee for transportation from the airport to a particular hotel or venue, wherein an ad is also generated for a reservation for lunch or dinner at a discount at a particular restaurant especially where the restaurant is low on customers at that time. Such functionality may be tied to an existing restaurant reservation system like “open table.”

The process 200 may further include identify promotional opportunities at block 230. For example, promotional opportunities may be identified based on profile information, past travel history, current destinations. A voucher is generated and delivered at block 240. The voucher may include a UPC code, QR code, serialized number, or other ID, and may be delivered via email or mobile device. The reservation manager 122 may maintain a record of the voucher.

The process 200 may include validating the voucher at a venue at block 250. Once the customer approaches a curb outside the venue, voucher may be validated by scanning in some manner, such as RFID, or other technology. A message may be transmitted back to the reservation manager 122 indicating that the voucher has been redeemed. Thereafter, the voucher ID (UPC, QR Code, Serial Number) may be marked as invalid so it cannot be redeemed more than once.

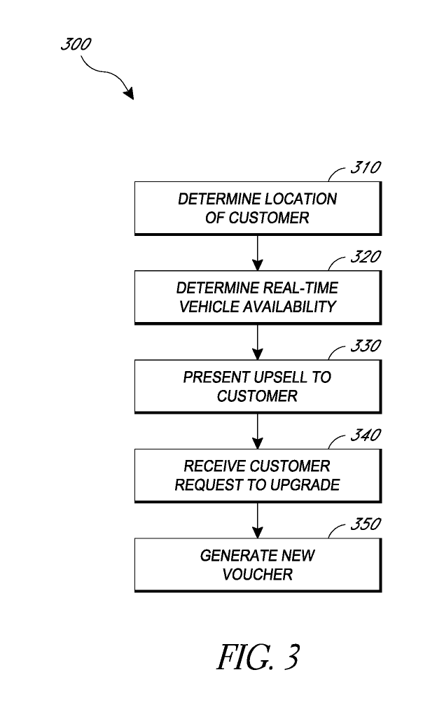

FIG. 3 is a flowchart illustrating an embodiment of a process 300 for real-time location-based upselling. The process 300 includes determining the location of a customer at block 310. Locating may be performed using GPS functionality. For example, in certain embodiments, when a customer's mobile device is at an airport, a mobile application may alerts the reservation management system. Alternatively, a customer may be located when he or she checks in at a Kiosk, as described herein. The customer may have already made a reservation or registered with the system to get a list of cars available when landing.

The process 300 may include determining real-time vehicle availability at block 320. For example, availability may be monitored/queried for vehicles in a queue. At block 330, an upsell offer is presented to the customer. Such offer may be in the form of an alert sent to the customer's mobile device including available cars/prices, wherein the customer may select from the list. At block 340, a customer request to upgrade is received. In response, a message may be sent to the reservation manager modifying/creating a new reservation based on the upsell offer. A new voucher may then be generated and sent to the customer at block 350. If the reservation is an updated reservation, a previous voucher ID may be marked by the system as “redeemed.” Alternatively, a new reservation may be created that is associated with the old voucher ID.

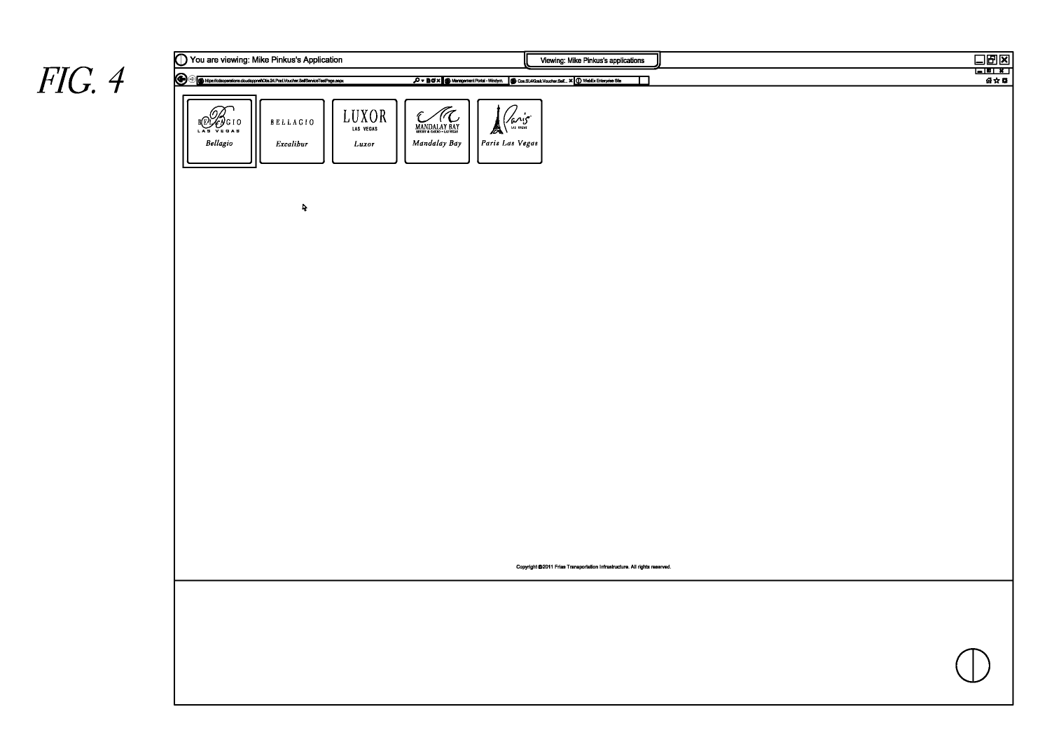

FIG. 4 illustrates one embodiment of a user interface screen that may be displayed on the kiosk. The user interface screen of FIG. 4 may show one or more icons depicting popular destinations. For example, the illustrative embodiment of FIG. 4 shows five popular hotels and casinos in Las Vegas. To start the reservation process, a passenger may select one of the icons. The kiosk, in one embodiment, may provide a touchscreen interface. In other embodiments, it may provide an input device, such as a mouse or light pen, for inputting selection and other information into the screen. The icons of FIG. 4 may be arranged based on:
Alphabetical order
Advertising revenue: the kiosk operator may sell locations of the kiosk screen, or in other embodiments, the kiosk operator may auction placement
Popularity: as certain destinations are selected they may move higher in the icon placement list. For example, the icon placement of day 1 may have “Luxor” as the first option, but as more people choose to travel to Bellagio, Bellagio may then become the first option in the list.

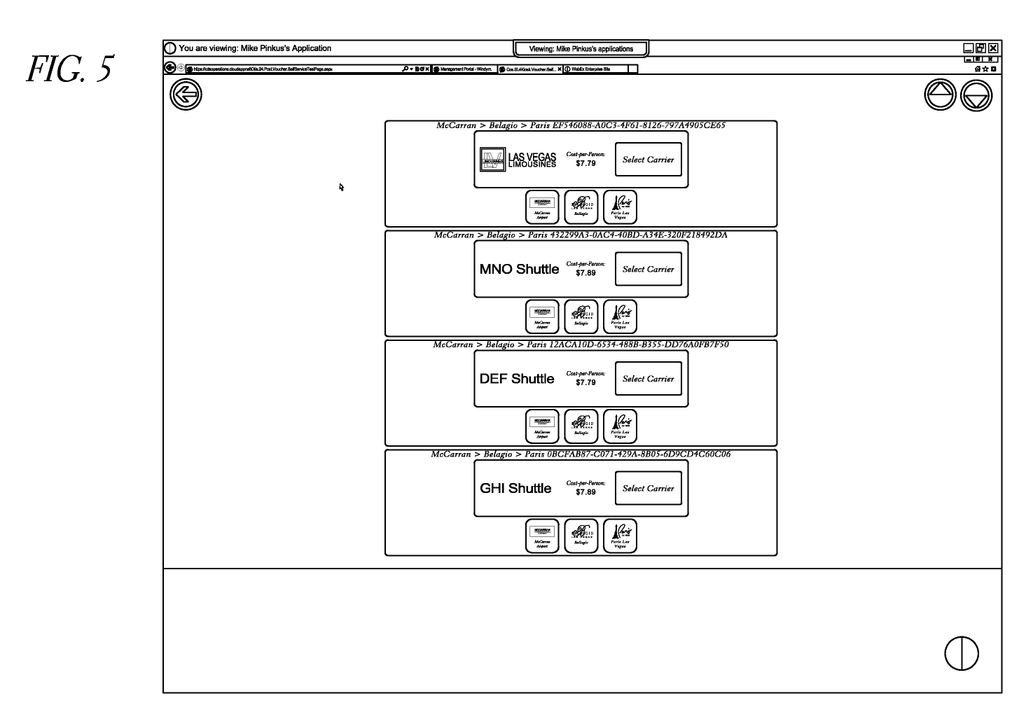

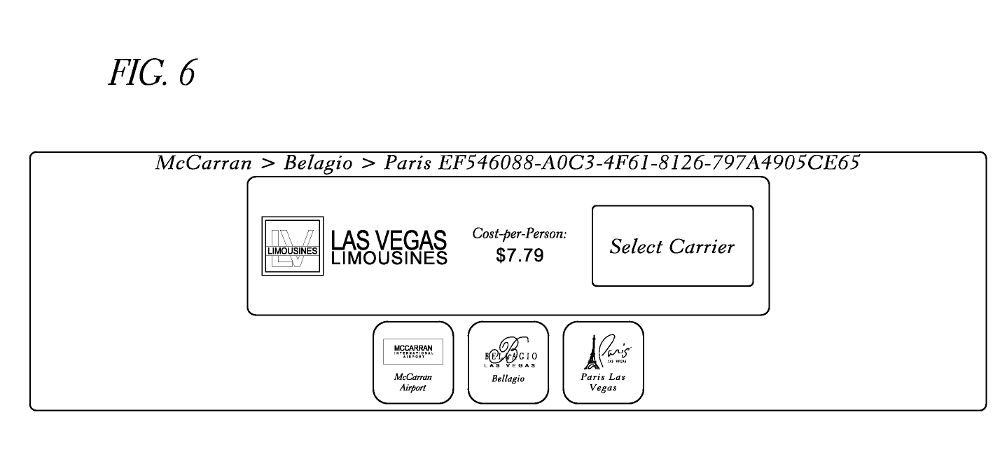

FIGS. 5 and 6 illustrate one embodiment of a route information screen that may be displayed on the kiosk. FIG. 5 shows a main view of the route information screen, while FIG. 6 shows a detail of the first shuttle route option presented in FIG. 5. The route information screen may display offers for shuttle services from one or more shuttle companies. Presenting several route options to passengers advantageously enables them to choose the best shuttle route for their needs. For example, passengers may be willing to pay more for a shuttle that stops at their destination earlier in the route. On the other hand, budget conscious passengers may be willing to take a route with more stops before their destination if that shuttle service is less expensive than other options. The route information may be displayed by showing the stops along the route for the shuttle. For example, in the route information box of FIG. 6, passenger is informed that the shuttle's route will start at the airport, then drop passengers off at Bellagio, and finally drop passengers off at Paris.

In addition to the route information, other information that may be of interest to the passenger may advantageously be provided. For example:
the expected time to each destination (minutes into route [“15 mins”] or absolute time [“5:13 PM”])
the expected wait time until pick-up
the distance from the kiosk to the door where the shuttle picks-up the passenger
customer satisfaction reviews
real time updates of route stops and time to destination for a variable route shuttle where the route of the shuttle depends on the passenger selected destinations.

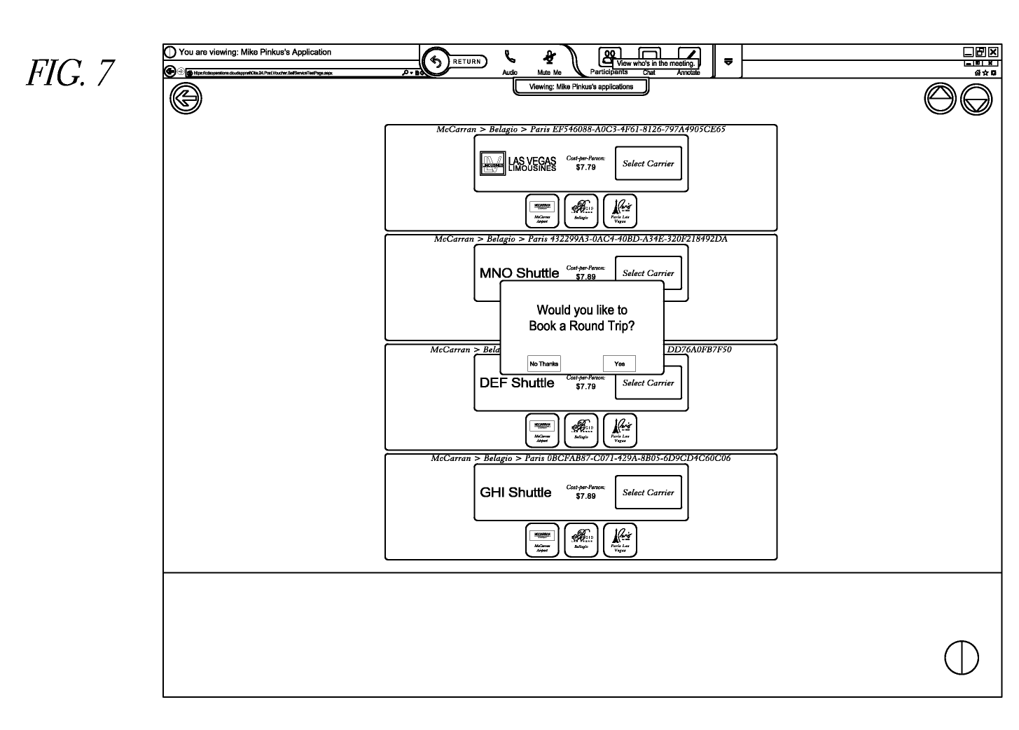

FIG. 7 illustrates one embodiment of a round trip request user interface. Pricing advantages may apply if the passenger selects a round trip. For example, a one way trip from the airport to Luxor may be $12, and one way trip from Luxor to the airport may be $12, but a round trip may be $20.

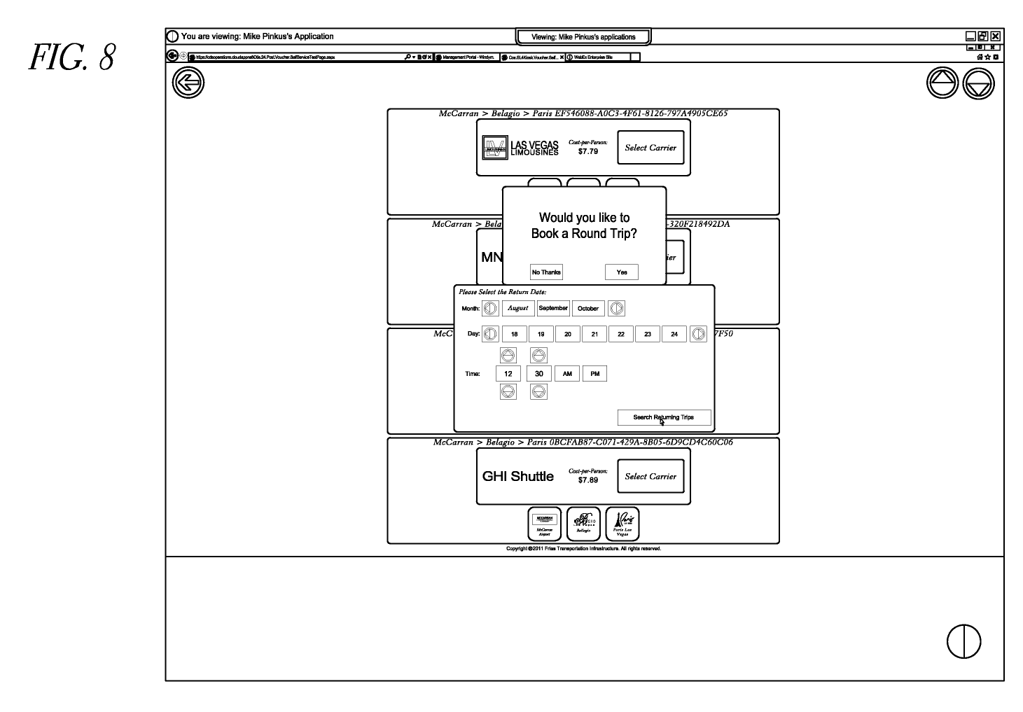

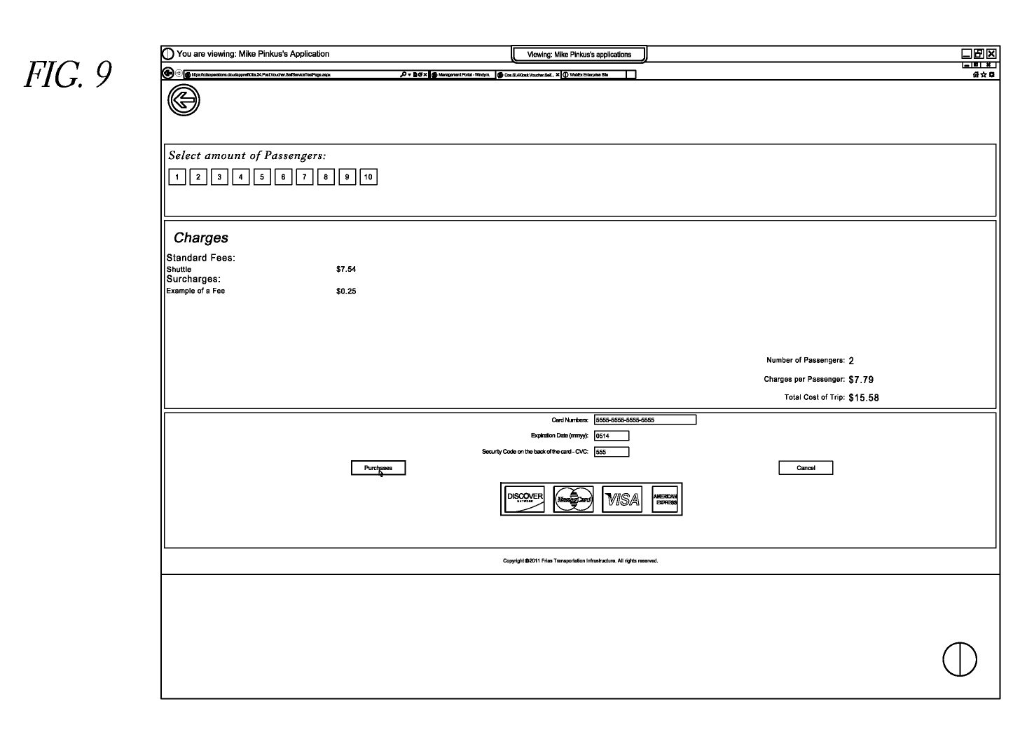

FIG. 8 illustrates one embodiment of a date selector user interface for selecting the date of a return trip for a round trip reservation. When a round trip is booked, the passenger may receive an alert via text message or email reminding the passenger of the reservation. In other embodiments, the central computer may send an alert via text message or email indicating that the shuttle is en route to pick up the passenger, or that the shuttle is experiencing delays. FIG. 9 illustrates one embodiment of a payment confirmation screen.

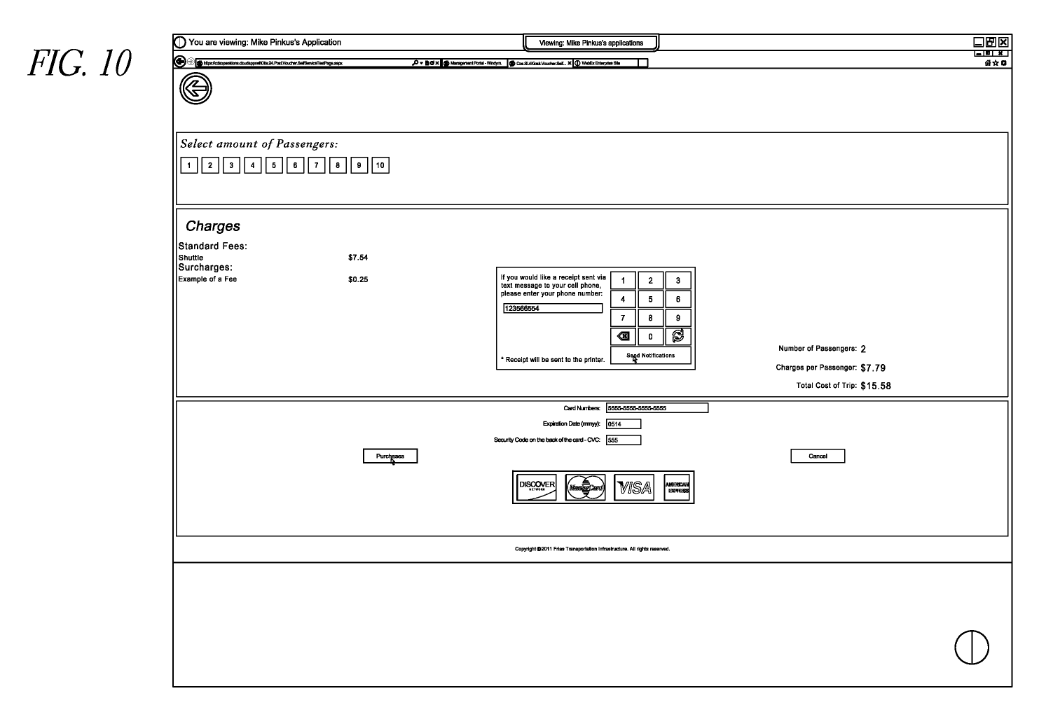

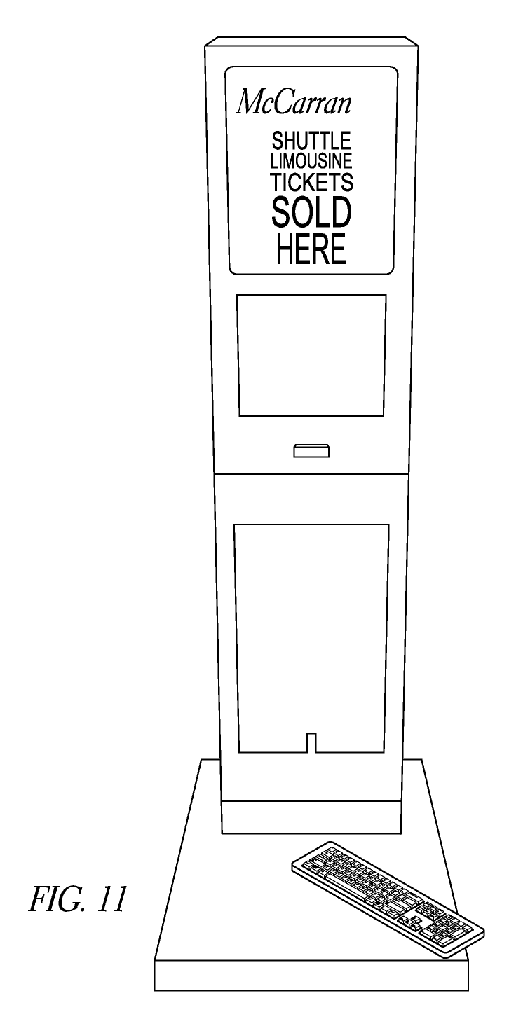

FIG. 10 illustrates one embodiment of a user interface for inputting a mobile telephone number so that the passenger may receive a voucher receipt or alerts to his mobile phone.

In some embodiments, the kiosk may be part of a larger networked computer system, with a central computer to form a backend accounting system and kiosks at several airports and other travel locations within and outside the USA. The kiosks are preferably set up to handle local reservations for shuttle buses (and other transportation, lodging or dining options) however the kiosks may advantageously permit the user to make reservations from another kiosk location so that the reservations will be set up and ready to go upon arrival. The central computer system provides for the possibility of generating contemporaneous passenger throughput reports that may be of value to airports or shuttle services. For example, demand for shuttle services may be estimated. The central computer system may also provide passenger data that may be used to update the route information provided in the user interface described in FIGS. 5 and 6.

When a passenger purchases a fare for shuttle service, they may receive a voucher or ticket. The voucher may contain a serialized number that is good for one trip on the shuttle. Once the passenger redeems the voucher, the driver may validate it. The validation is advantageously recorded in the central computing system, indicating that the passenger has redeemed the voucher. The validation may be time stamped so that the redemption time of the voucher is recorded. When the passenger is dropped off at their location, the driver may then record the drop off. The drop off may also be time stamped. Thus a round trip time may be calculated based on the purchase time, the redemption time and the drop-off time. This data may be fed back into the system so that estimated arrivals times displayed on the user interface described in FIGS. 4 and 6 are accurate and automatically updated.

In addition, the central computing system may also be able to estimate overall passenger traffic at the airport based on the shuttle use. Currently, many airports are unable to estimate their passenger traffic because airlines may be unable or unwilling to share passenger data with the airport. The central computing system advantageously provides data for shuttle use over time, which may then be extrapolated to determine overall airport passenger traffic.

Other features of the kiosk and for hire vehicle utilization system may advantageously include:
the ability to directly select a hotel destination and pay for that full amount right at the kiosk;
automatically increase the number of shuttle buses in light of real time demand;
providing a printed map to help the visitor locate where the shuttle bus will take off from at the airport; and
unique advertising opportunities based on information learned about the passengers who will be on the shuttle at the time they make their reservations and collect their vouchers.

In some embodiments, kiosks may be geographically separated and connected as part of a larger computer network thereby providing the ability for passengers to reserve shuttle service from a remote location. For example, if a passenger is flying from Los Angeles to Las Vegas, the kiosk system may advantageously provide a means for reserving the Las Vegas shuttle while waiting for a plane flight in Los Angeles. Access to the kiosk system could be made available to selected customers through smart phones and the internet or text based systems. Once reserved, the serialized voucher may be sent to the passenger's mobile device, or, may be printed at the kiosk. Once the passenger arrives in Las Vegas, he may then proceed directly to the shuttle.

In one embodiment, the kiosk system may be in communication with the baggage handling systems of their associated airport, thereby providing automatic baggage routing for the passenger. Using the example from the previous paragraph, when the passenger attempts to reserve a shuttle for his arrival in Las Vegas from the kiosk located in Los Angeles, the Los Angeles kiosk may provide a means for the passenger to associate his luggage with his shuttle reservation. This may be done for example, through the use of an RFID tag placed on the luggage, or may be done through an optical scan of the luggage tag affixed to the luggage by airline personal at check-in or by the customer using the kiosk or the customer's mobile phone scan code app. When the passenger arrives in Las Vegas, airport personal may scan the luggage and determine information regarding the passenger's shuttle reservation. Using that information, the luggage may then be routed to the appropriate shuttle thereby eliminating the need for the passenger to pick up his luggage in baggage claim. In some embodiments, the luggage may be routed to the passenger's hotel, as opposed to the reserved shuttle. In so doing, the passenger may proceed without delay to his destination hotel without having to wait for his baggage to meet him at the shuttle. Alternatively the luggage information could be scanned in from the luggage tags at the kiosk in Las Vegas when the passenger arrives and this information would be send to the appropriate system or personnel at the airport and at the customers hotel so that the luggage is routed to the shuttle bus and to the customer's hotel to be delivered directly to the customer's room at the hotel.

FIG. 8 illustrates one embodiment of the kiosk. The kiosk may comprise, as illustrated in FIG. 8, an advertisement display, a touchscreen display, a credit card reading device, a keyboard, and a base portion. The advertisement display, in one embodiment, may be static, that is, it may display a single advertisement or message. In other embodiments, the advertisement display may be a dynamic display that may show videos or change advertising or messages. In some embodiments, the dynamic display may show advertisements or message corresponding to a passenger making a reservation. For example, if the passenger has selected a hotel as a destination, the dynamic display may show an advertisement for a restaurant or show at the hotel while the passenger completes his reservation. In addition, the dynamic display may show information or advertisements for goods or services available at the location of the kiosk. The display may advantageously provide suggestions for the passenger to spend his time before the shuttle is able to pick him up. For example, if the passenger must wait for 15 minutes before the shuttle is to pick him up, the dynamic display may show an advertisement for video poker or slot machines that are located close to the kiosk thereby providing a suggestion to the passenger for how to spend his or her wait time.

The specific dimensions and implementations of any of the embodiments disclosed herein can be readily varied depending upon the intended application, as will be apparent to those of skill in the art in view of the disclosure herein. In a similar manner, certain embodiments refer to specific numbers of components or modules and specific component parts and modules which can also be varied and substituted as will be apparent to those of skill in the art in view of the disclosure herein. Moreover, although the present inventions have been described in terms of certain preferred embodiments, other embodiments of the inventions including variations in the number of parts, dimensions, configuration and materials will be apparent to those of skill in the art in view of the disclosure herein. In addition, all features discussed in connection with any one embodiment herein can be readily adapted for use in other embodiments herein to form various combinations and sub-combinations. The use of different terms or reference numerals for similar features in different embodiments does not imply differences other than those which may be expressly set forth. Accordingly, the present inventions are intended to be described solely by reference to the appended claims, and not limited to the preferred embodiments disclosed herein.

What is claimed is:

1. A kiosk disposed within a transportation terminal, the kiosk comprising:
a computer memory that stores information associating a for-hire vehicle (FHV) trip with an identifier; and
a processor in communication with the memory, the processor programmed to receive data input by a user, the data relating to the FHV trip;
wherein the processor is further programmed to generate a voucher for the FHV trip and provide the voucher to the user in response to receiving the data from the user.

2. The kiosk of claim 1, further comprising a user input device, wherein the data is input by the user using the user input device.

3. The kiosk of claim 2, wherein the user input device is a keyboard.

4. The kiosk of claim 2, wherein the user input device is a touch-screen display.

5. The kiosk of claim 1, wherein the kiosk is configured to print a copy of the voucher for the user having the identifier printed thereon.

6. The kiosk of claim 5, wherein the voucher is a booklet including a plurality of pages, at least one of the pages having promotional content printed thereon.

7. The kiosk of claim 1, wherein the identifier is one of the following: a UPC, a QR code, or an alpha-numeric string.

8. The kiosk of claim 1, wherein the transportation terminal is an airport.

9. A method for providing for-hire-vehicle (FHV) trip vouchers, the method comprising:
disposing a kiosk in a region of a transportation terminal;
receiving authentication data associated with a user;
identifying the user based at least in part on the authentication data;
receiving a request for an FHV trip voucher from the user;
identifying promotional content relevant to the user based at least in part on user profile information; and
printing, using the kiosk, an FHV trip voucher for the user, wherein the voucher includes the promotional content.

10. The method of claim 9, further comprising receiving a confirmation from an FHV driver that the voucher was redeemed.
